(19) United States
(12) Patent Application Publication
(10) Pub. No.: US 2025/0363969 A1
(43) Pub. Date: Nov. 27, 2025

(54) EFFICIENT CONFIGURATIONS OF COMPONENTS INCLUDED IN A PORTABLE DRUM KIT

(71) Applicant: Beatbox Drums LLC, Pocono Lake, PA (US)

(72) Inventor: Mathew Verderosa, Long Beach, CA (US)

(73) Assignee: Beatbox Drums LLC, Pocono Lake, PA (US)

(21) Appl. No.: 18/669,895

(22) Filed: May 21, 2024

(51) Int. Cl. G10G 7/00; G10D 13/02; G10D 13/10; G10D 13/11; G10D 13/22

(52) U.S. Cl. CPC G10G 7/005; G10D 13/02; G10D 13/11; G10D 13/22; G10D 13/28

(57) ABSTRACT

A compact configuration of individual elements forming a drum kit is proposed. In particular, modifications to the drum shell, foot pedal and stand are utilized to create a more compact arrangement for storage of these elements into a known cabinet configured for transporting a complete, portable drum kit. The drum shell may be formed of a lightweight, inexpensive plastic material that may be machined to create a plurality of beveled staves that may be stored “flat” and re-configured into a rounded configuration during set up of the drum kit. This type of drum shell may be used for various sizes and types of snare drums and/or tom-tom drums. A modified drum pedal is proposed that conveniently folds for storage, as well as a foldable stand.

### TECHNICAL FIELD

The present invention relates to the field of portable drum kits and, more particularly, to the formation of reconfigurable, compact components that are more convenient for storage and transport.

### BACKGROUND OF THE INVENTION

Prior development efforts on simplifying the portability of typical drum kits is disclosed and described in detail in co-owned U.S. Pat. No. 9,449,588 issued Sep. 20, 2016, which is incorporated herein by reference.

Briefly, the portable drum kit as described in the above-referenced patent is based upon the concept of acoustically configuring the kit's storage container to function as a base drum and thus reduced the number of individual components that need to transported from one venue to another.

What is presented here are a set of improvements to the original design that are contemplated to further increase the compact nature of various elements included within the drum kit.

### SUMMARY OF THE INVENTION

As will be described in detail below, modifications to the drum shell, foot pedal and stand are proposed that create a more compact arrangement for transportation without impacting the musical quality of the drum kit.

In accordance with the principles of the present invention, a drum shell may be formed of a lightweight, inexpensive plastic material that may be machined to create a plurality of beveled staves that may be stored “flat” and re-configured into a rounded configuration during set up of the drum kit. This type of drum shell may be used for various sizes and types of snare drums and/or tom-tom drums. A modified drum pedal is proposed that conveniently folds for storage, as well as a foldable stand.

An exemplary embodiment takes the form of a portable drum kit comprising at least one drum having a shell component formed of a sheet of material having a desired thickness, wherein the sheet of material is processed to create a plurality of beveled staves created perpendicular to a length of the sheet of material, the bevel angle selected such that the sheet of material may be re-configured into circular form with opposing ends attached to form the shell component.

Other and further aspects and features of the present invention will become apparent during the course of the following discussion and by reference to the accompanying drawings.

### BRIEF DESCRIPTION OF THE DRAWINGS

Referring now to the drawings, where like numerals represent like parts in several views:

FIG. 1 depicts an exemplary portable drum kit that may utilize one or more of the compact elements formed in accordance with the principles of the present invention;

FIG. 2 is an isometric view of an exemplary drum formed in accordance with the present invention to include a drum shell comprising a plurality of (plastic) beveled staves;

FIG. 3 shows an example of a starting material that may be used to form the drum shell of FIG. 2;

FIG. 4 is a side of a single stave of the inventive drum shell, illustrating a typical bevel that may be formed;

FIG. 5 is an isometric view of an inventive drum pedal formed in accordance with the principles of the present invention;

FIG. 6 is a side view of the drum pedal of FIG. 5;

FIG. 7 is an isometric view of an exemplary collapsible high-hat cymbal stand formed in accordance with the principles of the present invention;

FIG. 8 illustrates the high-hat cymbal stand of FIG. 7 as it is beginning to be folded into its collapsed configuration;

FIG. 9 shows the inventive high-hat cymbal stand in its final compact, collapsed form useful for storage; and

FIG. 10 is an isometric view of an exemplary drum seat formed in accordance with the present invention to be re-configured into a smaller volume arrangement for storage.

### DETAILED DESCRIPTION

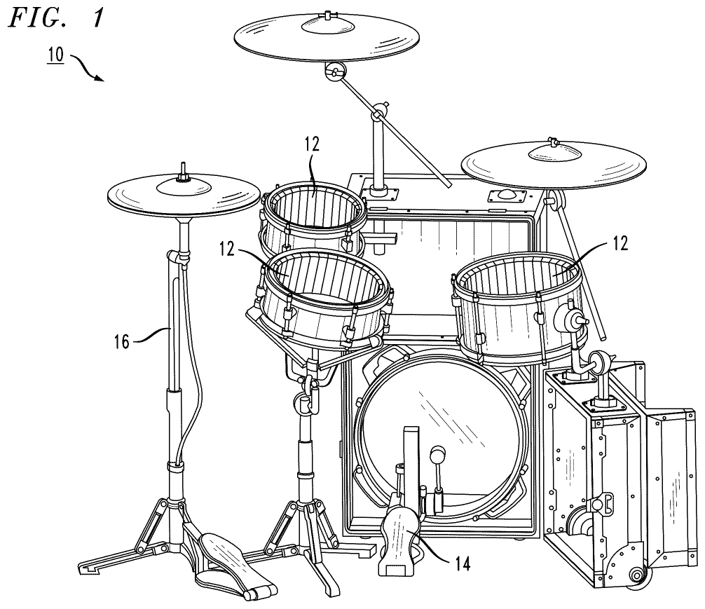

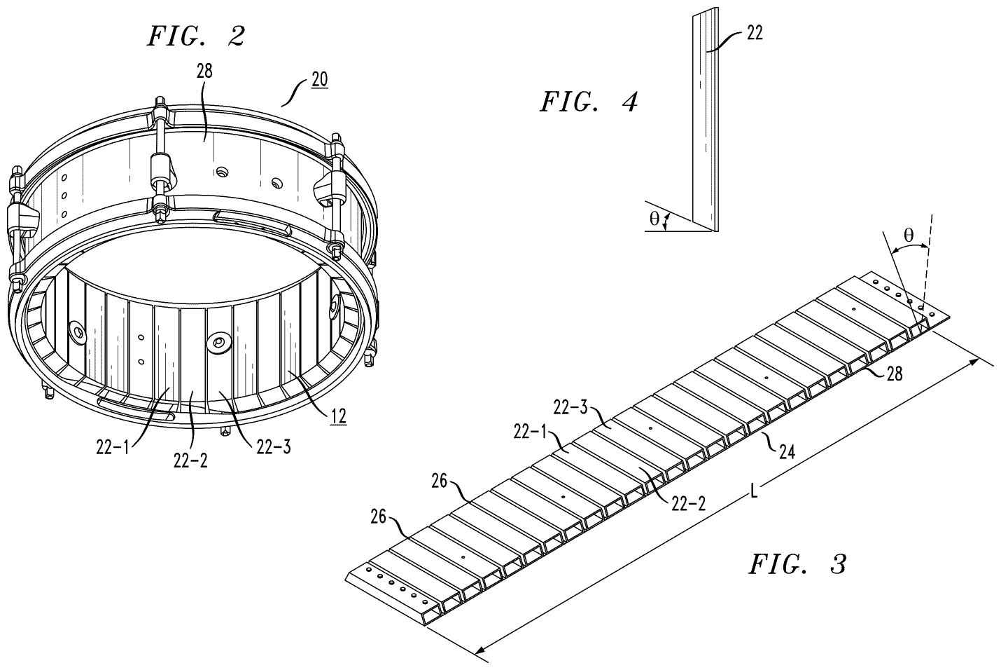

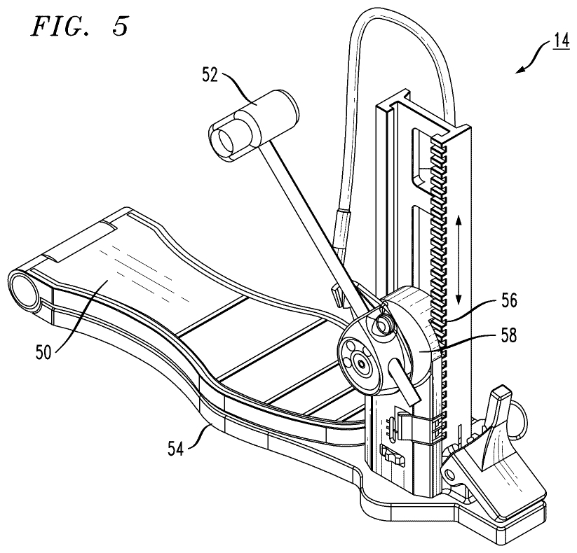

FIG. 1 is an isometric view of an exemplary drum kit 10 formed in accordance with the principles of the present invention, where the following items will be described in more detail below. In particular, a drum shell 12 will be discussed below in association with FIGS. 2-4 A bass pedal 14 will be discussed below in association with FIGS. 5-7, and a hi-hat stand 16 with FIG. 5.

An example drum 20 is shown in FIG. 2. Drum 20 may be, for example, a snare drum or a tom-tom drum, where both are shown in FIG. 1. Drum 20 is depicted in an isometric view in FIG. 2, looking into the drum from underneath. In accordance with the teachings of the present invention, drum 20 includes an inventive drum shell 12 that is formed of a lightweight material. In particular, inventive drum shell 12 is shown as including a plurality of staves 22 (with particular staves 22-1, 22-2 and 22-3 denoted in FIG. 2).

Advantageously, the plurality of staves 22 may be formed by controlled machining of a single length of material 24. FIG. 3 shows a length of material 24 (for example, a plastic) that may be processed to form the plurality of staves 22 in a manner where they may be positioned in a circular form to create the drum shell. Continuing with reference to FIG. 3, material 24 is processed to create spaced-apart bevel cuts 26 at predetermined locations along length L of material 24. FIG. 4 is a side view of an exemplary stave 22, showing an exemplary bevel angle θ.

These beveled cuts form notches that allow for drum shell 12 to be curved in a rounded form as shown in FIG. 2. Advantageously, drum shell 12 may be formed of recycled plastic, with an automated cutting tool used to quickly and easily fabricate the structure as shown. In fact, a CNC machine may be used to make the necessary beveled cuts, controlling the depth of cut so that the outer periphery 28 of the shell remains intact.

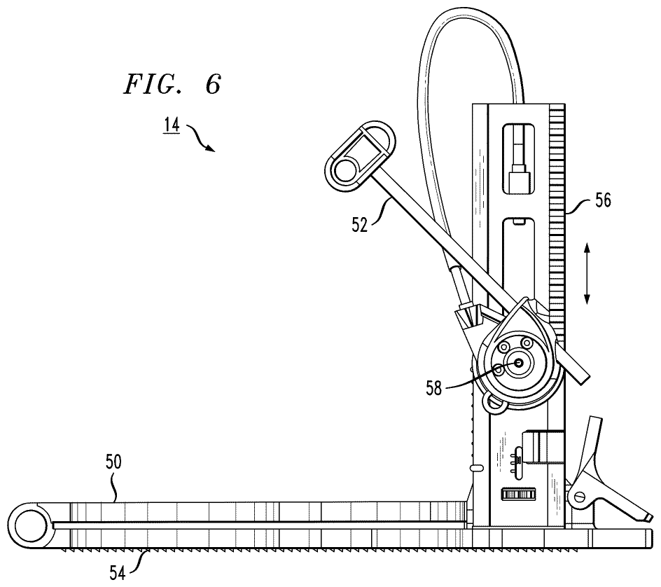

An isometric view of an exemplary bass pedal 14 is shown in FIG. 5 as including a foot support 50 and an adjustable striking bar 52. FIG. 6 is a side view of bass pedal 14. In accordance with the present invention and as best seen in FIG. 6, foot support 50 is formed to include a textured underside 54 that allows for the pedal to grip a drum mat may be is used to support the drum kit during use. Inasmuch as the individual components forming drum kit 10 are lightweight (by design), the inclusion of textured underside 54 is a feature that keeps bass pedal 14 from “creeping” away from the musician during use.

Referring to both FIGS. 5 and 6, striking bar 52 is particularly configured so that is may be raised or lowered by movement along a vertical geared member 56. The ability to adjust the position of striking bar 52 allows for changes to be made from one user to the next, so that an individual is always in control of the area on the drum ahead that is being struck. A unique spring configuration 58 is used to control the force applied by striking bar 52 to the drum head.

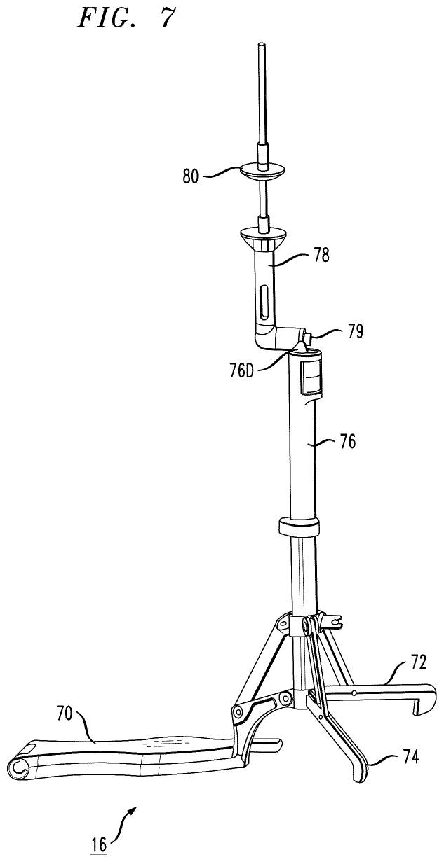

FIGS. 7-9 illustrate the compactness of a high-hat stand 16 that may be collapsible to travel within the container of drum kit 10, yet provide the capabilities necessary to provide a mechanically sturdy stand. FIG. 7 shows stand 16 it in its fully extended configuration; that is, ready for use upon attachment of a high-hat cymbal (not shown). High-hat stand 16 is shown as including a foot pedal 70 (used for controlling the opening and closing of a high-hat cymbal in a conventional manner) and a pair of support legs 72, 74. Foot pedal 70 and legs 72, 74 are attached to a vertical column post member 76. A movable post member 78 is shown as attached to a distal termination 76D of vertical column post member 76 via a hinge 79. An example mechanism 80 used to attach a high-hat cymbal to stand 16 is also shown.

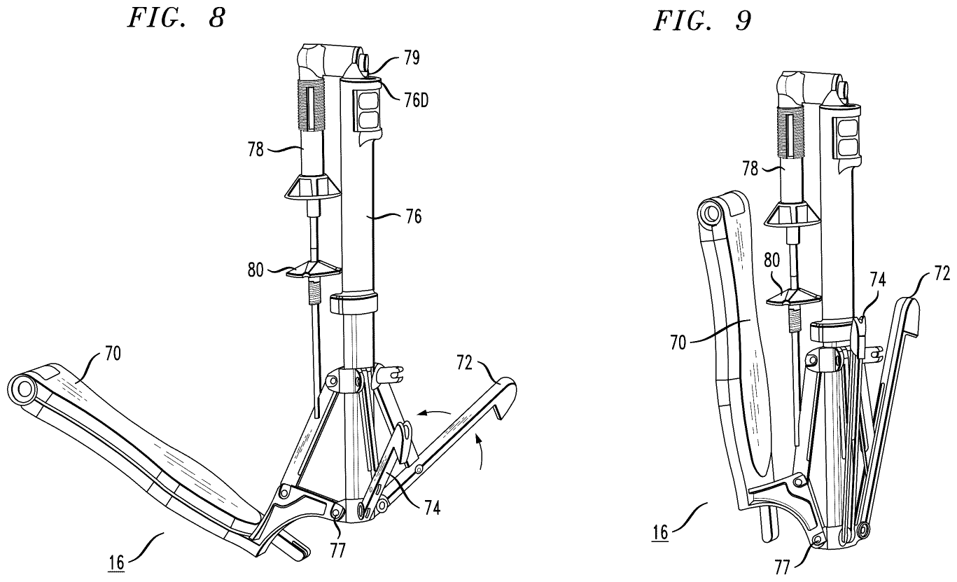

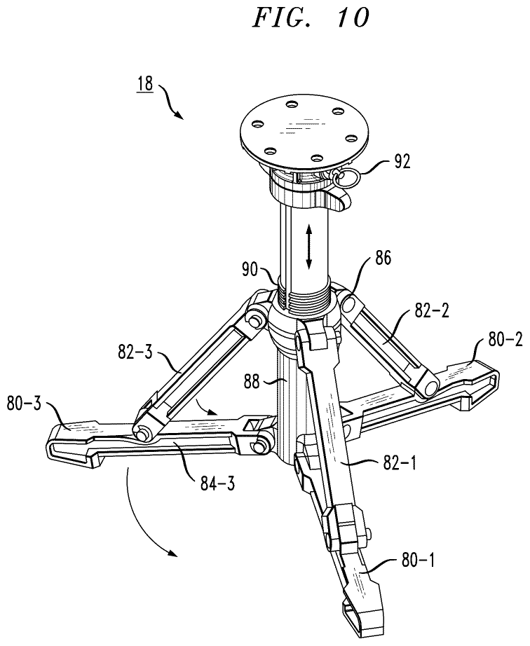

FIG. 8 shows high-hat stand 16 in a first step of re-configuration for storage purposes (for example, for transport within the container of drum kit 10). In particular, movable post member 78 is shown as now being rotated downward via hinge 79 (i.e., “folded”) so as to now be adjacent to vertical column post member 76. Legs 72 and 74 are also being folded toward vertical column post member 76. Finally, as shown in FIG. 9, foot pedal 70 has also been rotated upward to close against vertical column past member 76. In this case, a hinge mechanism 77 is used to control the movement of foot pedal 70.

FIG. 10 illustrates an exemplary drummer's seat 18 (also referred to at time by drummer's as the “throne”) that is also particularly configured for compact storage. It is to be understood that the actual cushioned seat component is not shown in this drawing. For the purposes of the present invention, throne 18 is formed to comprise a set of three equi-spaced legs 80, with an associated set of links 82 coupled to legs 80 in a one-to-one manner to ride within a channel 84 formed in each leg 80. This configuration is best shown for the combination of leg 80-3 with link 82-3 and channel 84-3. The opposing end of each link 82-I is attached to a collar 86 disposed around a central column 88. In this embodiment, central column 88 includes a threaded portion 90 that may rotated to control the height of throne 18 (as shown by the double-ended arrow in FIG. 10). A locking pin 92 may be used “fix” the height of throne 18 once all adjustments have been made by threaded portion 90. For stowing, legs 80 may be rotated downward in a manner that brings links 82 against central column 88, with legs 80 compacting against each other.

It is to be understood that the various features of a compact drum kit formed in accordance with the teachings of the present invention may include various other configurations, as well as other features for those components as described in detail above. Thus, the spirit and scope of the present invention is not limited by this description, but only by the claims appended hereto.

What is claimed is:

1. A portable drum kit comprising
at least one drum having a shell component formed of a sheet of material having a desired thickness, wherein the sheet of material is processed to create a plurality of beveled staves created perpendicular to a length of the sheet of material, the bevel angle selected such that the sheet of material may be re-configured into circular form with opposing ends attached to form the shell component.

2. The portable drum kit as defined in claim 1 wherein the shell component is formed of a sheet of plastic material.

3. The portable drum kit as defined in claim 1 wherein the plurality of beveled staves are creating using a machining process.

4. The portable drum kit as defined in claim 3 wherein the plurality of beveled staves are created using a CNC machine.

5. The portable drum kit as defined in claim 1 wherein the at least one drum comprises at least one snare drum.

6. The portable drum kit as defined in claim 1 wherein the at least one drum comprises a tom-tom drum.

7. The portable drum kit as defined in claim 1, further comprising
a bass pedal having a foot support and an adjustable striking bar.

8. The portable drum kit as defined in claim 7, wherein the foot support includes a textured bottom surface to prevent movement during use.

9. The portable drum kit as defined in claim 7, further comprising a vertical gear member attached to the adjustable striking bar and configured to control a vertical positioning of the adjustable striking bar.

10. The portable drum kit as defined in claim 7, further comprising a spring-based tension member attached to the adjustable striking bar and configured to control the striking force applied to an associated drum.

11. The portable drum kit as defined in claim 1, further comprising a collapsible high-hat stand including:
a hinged foot pedal;
a pair of hinged leg supports disposed equi-distant from the hinged foot pedal;
a central support column attached to the hinged foot pedal and the pair of hinged leg supports; and
a hinged support member coupled to a distal termination of the central support column, such that upon stowing the high-hat stand the hinged support member is rotated downward against the central support column, the hinged foot pedal is rotated upward toward the central support column, and the pair of hinged legs is rotated upward toward the central support column.
